(19) United States
(12) Patent Application Publication
(10) Pub. No.: US 2016/0236684 A1
(43) Pub. Date: Aug. 18, 2016

(54) DRIVE ASSIST APPARATUS

(71) Applicant: TOYOTA JIDOSHA KABUSHIKI KAISHA, Toyota-shi (JP)

(72) Inventors: Masayuki KATOH, Gotenba-shi (JP); Minami SATO, Susono-shi (JP)

(73) Assignee: TOYOTA JIDOSHA KABUSHIKI KAISHA, Toyota-shi (JP)

(21) Appl. No.: 14/991,457

(22) Filed: Jan. 8, 2016

(30) Foreign Application Priority Data
Feb. 12, 2015 (JP) 2015-025008

(51) Int. Cl. B60W 30/095; B60W 30/08

(52) U.S. Cl. CPC B60W 30/0953; B60W 30/08; B60W 2550/308; B60W 2550/304; B60W 2900/00

(57) ABSTRACT

Provided is a drive assist apparatus in which, when performing a linear search on search target values with respect to each of a plurality of search information items, the increase of maximum value of the total number of searches in all of the plurality of search information items can be suppressed.

A drive assist apparatus 100 includes an assist determination unit 32 configured to, in calculation processing in a drive assist control of a host vehicle V, perform a linear search with respect to search information formed of a plurality of values. In a case of performing the linear search on the search target value which is the target of searching with respect to each of the plurality of search information items, the assist determination unit 32 alternately performs an ascending search and a descending search with respect to each search information.

### BACKGROUND OF THE INVENTION

1. Field of the Invention

An aspect of the present invention relates to a drive assist apparatus.

2. Related Background Art

There is a drive assist apparatus that performs a drive assist for vehicles. For example, in Japanese Unexamined Patent Application Publication No. 2009-294930, a drive assist apparatus that performs collision avoidance as the drive assist is disclosed. This drive assist apparatus determines whether or not there is a possibility of a collision between a host vehicle and another vehicle or the like, and in a ease where there is the possibility of collision, then, notifies a driver of that effect.

### SUMMARY

For example, in calculation processing for the drive assist control such as a collision determination, the drive assist apparatus searches values by a linear search. For example, the drive assist apparatus has a plurality of search information items (for example, a map or the like) formed of a plurality of values. The drive assist apparatus performs linear searches on each search target value which is a target of searching, in an ascending order or a descending order with respect to each of the plurality of search information items.

When performing the linear searches in the ascending order or the descending order, there is a case where the number of searches increases depending on the search target value. For this reason, when performing the linear searching on the search target value with respect to each of the plurality of search information items, there is a case where a maximum value of the total number of searches in all of the plurality of search information items increases, and thus, a processing load for performing the linear searches with regard to all of the plurality of search information items increases. Therefore, in this technical field, it is required to suppress the increase of maximum value of the processing load, that is, to suppress the increase of maximum number of searches.

Therefore, an object of the present invention is to provide a drive assist apparatus in which, when performing the linear searches on the search target values with respect to each of the plurality of search information items, the maximum value of the total number of searches in all of the plurality of search information items can be suppressed.

According to an aspect of the present invention, there is provided a drive assist apparatus including a search unit configured to, in calculation processing in a drive assist control of a vehicle, perform a linear search with respect to search information formed of a plurality of values. In a case of performing the linear search on a search target value which is a target of searching with respect to each of a plurality of search information items, the search unit alternately performs an ascending search and a descending search with respect to each search information,

For example, even when the number of searches increases in a case of searching the predetermined search target value by the ascending search, the number of searches decreases in a case of searching the predetermined search target value by the descending search. For this reason, when performing the linear search on the search target value with respect to each of the plurality of search information items, the drive assist apparatus alternately performs the ascending search and the descending search with respect to each search information. In this way, the drive assist apparatus can suppress the increase of the maximum value of the total number of searches in all of the plurality of search information items,

The drive assist control is a collision avoidance assist control for assisting collision avoidance between a host vehicle and an obstacle around the host vehicle. The drive assist apparatus further includes a time calculation unit configured to calculate as time to collision which is as time for the host vehicle and the obstacle to collide with each other, a speed detection unit configured to detect a speed of the host vehicle, an assist unit configured to perform an assist for avoiding the collision between the host vehicle and the obstacle, and a storage unit configured to store the plurality of search information items. A determination reference value which is a reference for determining the necessity of executing the collision avoidance assist control is associated with each value forming the search information. The search unit performs linear searches on the value of the speed detected by the speed detection unit as a search target value with respect to each of the plurality of search information items, and determines the necessity of executing the collision avoidance assist control based on the determination reference value associated with the found value and the time to collision calculated by the time calculation unit. The assist unit may execute the collision avoidance assist control based on the result of the determination by the search unit. In this case, when performing the collision avoidance assist control, even in a ease of performing the linear search with respect to the search information, it is possible to suppress the increase of maximum value of the total number of searches in all of the plurality of search information items. Therefore, the drive assist apparatus can suppress the increase of maximum value of the processing load in the collision avoidance assist control.

According to an aspect of the present invention, when performing the linear searches on the search target value with respect to each of the plurality of search information items, the drive assist apparatus can suppress the increase of maximum value of the total number of searches in all of the plurality of search information items.

### BRIEF DESCRIPTION OF THE DRAWINGS

FIG. 1 is a diagram illustrating a schematic configuration of a drive assist apparatus in an embodiment.

FIG. 2A and 2B are diagrams illustrating examples of search information.

FIG. 3 is a flowchart illustrating a processing flow for determining a necessity of executing a collision avoidance assist control.

### DESCRIPTION OF THE PREFERRED EMBODIMENTS

Hereinafter, an embodiment of the present invention will be described with reference to the drawings. In the description of the drawings, the same reference numerals are given to the same elements and the descriptions thereof will not he repeated.

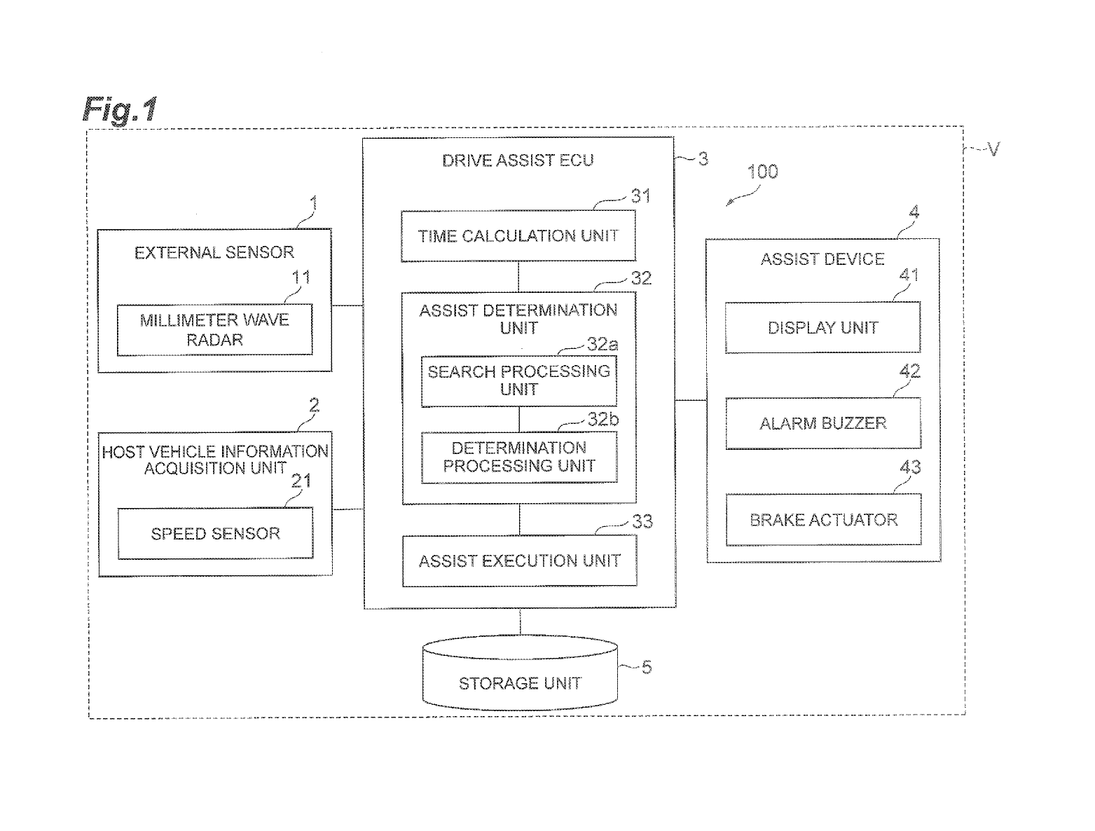

A drive assist apparatus 100 illustrated in FIG. 1 is mounted on a host vehicle (a vehicle) V such as a passenger car. The drive assist apparatus 100 assists a driving operation of a driver. The drive assist apparatus 100 in the present embodiment performs a collision avoidance assist which is an assist for avoiding a collision between the host vehicle V and an obstacle around the host vehicle V as the drive assist. The obstacle around the host vehicle V is an object that has a possibility of a collision with the host vehicle V, and includes another vehicle in travelling, another vehicle in stopping or parking, a construction facility such as a pylon for construction, a pedestrian, and a wall. In the present embodiment, the obstacle around the host vehicle V is assumed to be a preceding vehicle that travels in front of the host vehicle V.

The drive assist apparatus 100 includes an external sensor 1, a host vehicle information acquisition unit 2, a drive assist electronic control unit (ECU) 3, an assist device 4, and a storage unit 5.

The external sensor 1 is a sensor that detects an obstacle around the host vehicle V. The external sensor 1 in the present embodiment includes millimeter wave radar 11 as an example. The millimeter wave radar 11 is provided, for example, on the front end of a vehicle body of the host vehicle V, and detects an obstacle in front of the host vehicle using a millimeter wave. The millimeter wave radar 11 detects the obstacle by transmitting a millimeter wave to the front of the host vehicle and receiving a millimeter wave reflected from the obstacle. The millimeter wave radar 11 transmits information on the detected obstacle to the drive assist ECU 3.

The host vehicle information acquisition unit 2 acquires information relating to a behavior of the host vehicle V. The host vehicle information acquisition unit 2 in the present embodiment includes a speed sensor (speed detection unit) 21. The speed sensor 21 is a detector that detects a speed of the host vehicle V. For example, a vehicle wheel speed sensor which is provided on vehicle wheels of the host vehicle V or on a drive shaft which rotates integrally with the vehicle wheels and detects a rotation speed of the vehicle wheels is used as the speed sensor 21. The speed sensor 21 transmits the detected speed of the host vehicle V to the drive assist ECU 3.

The assist device 4 is a device that performs an assist for avoiding a collision with a preceding vehicle. The assist device 4 includes a display unit 41, an alarm buzzer 42, and a brake actuator 41

The display unit 41 is mounted on a position in a room of the host vehicle V where the driver of the host vehicle V can visually recognize. The display unit 41 may be, for example, a display unit of a navigation system. The alarm buzzer 42 is mounted in the room of the host vehicle V and is a device that can output a sound. The brake actuator 43 is an actuator that causes the brake of the host vehicle V to operate.

The drive assist ECU 3 performs calculation processing of the drive assist control which is a control for assisting the driving operation of the driver. In the present embodiment, the drive assist ECU 3 performs the collision avoidance assist control which is a control for assisting collision avoidance between the host vehicle V and the preceding vehicle as the drive assist control. The drive assist ECU 3 is an electronic control unit including a central processing unit (CPU), read only memory (ROM), random access memory (RAM), and the like. In the drive assist ECU 3, the control of various drive assists is performed. by loading the program stored in the ROM into the RAM and executing the program by the CPU. The drive assist ECU 3 may he configured of a plurality of electronic control units.

Next, a functional configuration of the drive assist ECU 3 will be described. The drive assist ECU 3 includes a time calculation unit 31, an assist determination unit (search unit) 32, and an assist execution unit (assist unit) 33.

The time calculation unit 31 calculates a time to collision (TTC) which is a time for the host vehicle V and the preceding vehicle to collide with each other. The TTC is a time that can be obtained by dividing a relative distance between the host vehicle V and the preceding vehicle in a travelling direction of the host vehicle V by a relative speed between the host vehicle V and the preceding vehicle in the travelling direction of the host vehicle V.

Specifically, first, the time calculation unit 31 recognizes the preceding vehicle in front of the host vehicle V. The time calculation unit 31 recognizes a vehicle-to-vehicle distance and the relative speed between the recognized preceding vehicle and the host vehicle V based on, for example, the obstacle information from the millimeter wave radar 11. Next, the time calculation unit 31 may recognize the TTC between the preceding vehicle and the host vehicle V based on, for example, the vehicle-to-vehicle distance and the relative speed between the recognized preceding vehicle and the host vehicle V.

The time calculation unit 31 calculates, for example, the TTC for each predetermined time interval. The time calculation unit 31 outputs the calculated TTC and the speed of the host vehicle V detected by the speed sensor 21 to the assist determination unit 32. The speed of the host vehicle V is the speed at the time when the TTC is calculated.

The assist determination unit 32 determines the necessity of executing the collision avoidance assist control. The assist determination unit 32 performs a linear search with respect to search information formed of a plurality of values, and determines the necessity of executing the collision avoidance assist control.

The search information is stored in the storage unit 5. Here, the search information stored in the storage unit 5 will be described. The search information is formed of a plurality of values. The storage unit 5 stores a plurality of search information items. In the present embodiment, a determination reference value which is a reference for determining the necessity of executing the collision avoidance assist control is associated with each value that forms the search information.

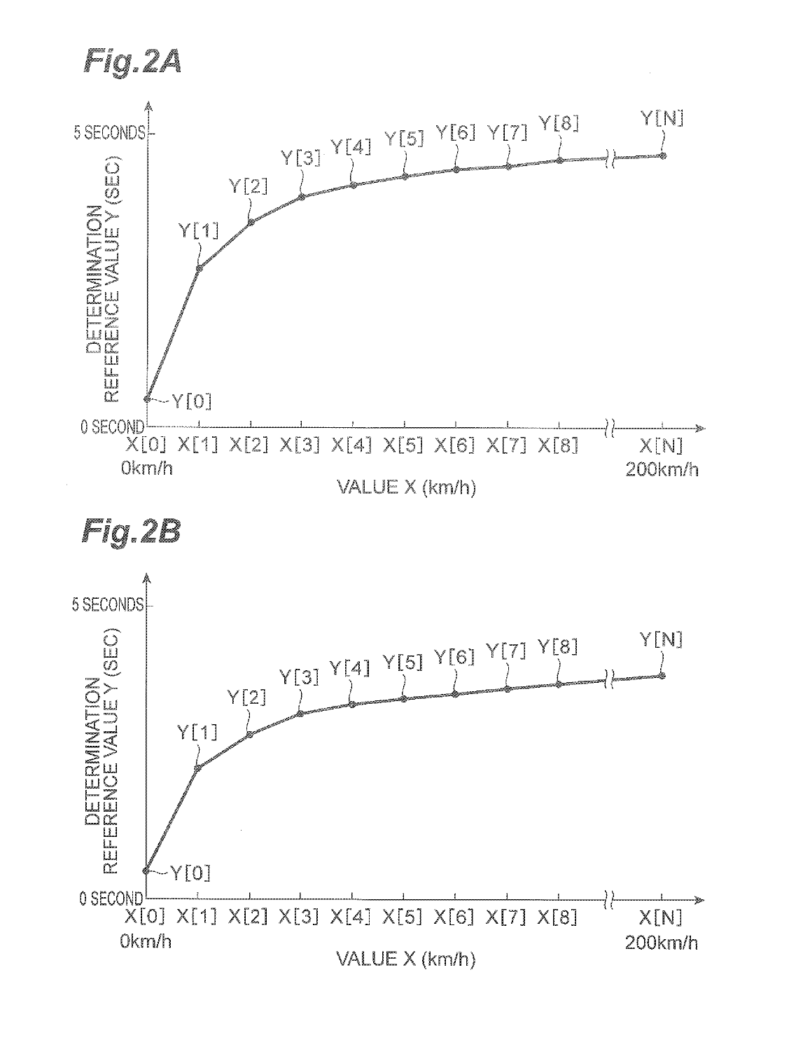

As an example, the search information can be indicated as a map illustrated in FIG. 2A. A horizontal axis of the map illustrated in FIG. 2A represents the speed (km/h) of the host vehicle V, and a vertical axis of the map represents the determination reference value seconds). Hereinafter, a plurality of values forming the search information is referred to as value X[i] (i=0 to N). As an example, the value X[i] may be a value for each predetermined speed (for example, for each 1 km/h, 5 km/h, or the like) among the speeds from 0 km/h to 200 km/h. The value X[i] increases from a value X[0] toward a value X[N] in an order. Each determination reference value which is respectively associated with each value X[i] is referred to as determination reference value Y[i] (i=0 to N). As an example, the determination reference value Y[i] may be a predetermined time between 0 seconds and 5 seconds.

The drive assist apparatus 100 executes various contents of assist as the collision avoidance assist. The plurality of search information items is created for each content of collision avoidance assist. The assist determination unit 32 determines the necessity of executing each of the content of assist by sequentially searching the plurality of search information items. In the present embodiment, the plurality of search information items has the same upper limit and the lower limit of the values X[i].

The assist determination unit 32 includes a search processing unit 32a, and a determination processing unit 32b. The search processing unit 32a performs the linear search on the search target value which is a target of searching with respect to each of the plurality of search information items stored in the storage unit 5. The search processing unit 32a sequentially performs the linear searches with respect to each search information. In addition, in a case of searching the search target value, the search processing unit 32a alternately performs the linear searches with respect to each of the search information items in an ascending order and a descending order.

In more detail, the search processing unit 32a uses the value of the speed of the host vehicle V detected by the speed sensor 21 as the search target value. The search processing unit 32a performs the linear search on the value of the speed of the detected host vehicle V with respect to each of the plurality of search information items stored in the storage unit 5. Specifically, the search processing unit 32a searches for a value X[i] that matches the value of the speed of the host vehicle V by comparing each value X[i] forming the search information and the value of the speed of the host vehicle V in the ascending order and the descending order. Then, the search processing unit 32a acquires a determination reference value Y[i] which is associated with the found value X[i]. Here, the ascending search means the search in which the value of the speed and the value X[i] are compared in an ascending order from the value X[0] which is a small value toward the value X[N] which is a large value. The descending search means a search in which the speed and the value X[i] are compared in a descending order from the value X[N] which is a large value toward the value X[0] which is a small value.

There is a case where the value of the speed of the host vehicle V and the value X[i] does not exactly match. In this case, the search processing unit 32a may acquire the determination reference value in association with the value of the speed of the host vehicle V by performing an appropriate interpolation such as a linear interpolation. As an example, the search processing unit 32a may acquire the determination reference value by a following procedure. For example, among the values X[i], the value X[i] which is smaller than the value of the speed of the host vehicle V and closest to the value of the speed of the host vehicle V is assumed to be a first value X[a]. Among the values X[i], the value X[i] which is larger than the value of the speed of the host vehicle V and closest to the value of the speed of the host vehicle V is assumed to be a second value X[a+1]. The search processing unit 32a may acquire the determination reference value corresponding to the value of the speed of the host vehicle V by linear interpolation or the like using a determination reference value Y[a] associated with the first value X[a] and a determination reference value Y[a+1] associated with the second value X[a+1].

The determination processing unit 32b compares the determination reference value acquired by the search processing unit 32a and the TTC calculated by the time calculation unit 31. The determination processing unit 32b determines the necessity of executing the collision avoidance assist control based on the comparison result. Specifically, the determination processing unit 32b determines whether or not the TTC is equal to or smaller than the determination reference value. In a case where the TTC is equal to or smaller than the determination reference value, the determination processing unit 32b determines that the execution of collision avoidance assist control is necessary. In addition, in a case where the TTC is not equal to or smaller than the determination reference value, the determination processing unit 32b determines that the execution of collision avoidance assist control is not necessary.

The assist execution unit 33 executes the collision avoidance assist control based on the determination result of the determination processing unit 32b. Specifically, in a case where the determination processing unit 32b determines that the execution of collision avoidance assist is necessary, the assist execution unit 33 causes the assist device 4 to operate according to the content of assist of which the execution is determined to be necessary.

For example, the assist execution unit 33 performs the control of notifying the driver of the fact that there is a possibility of collision by displaying the fact that there is a possibility of collision between the host vehicle V and the preceding vehicle on the display unit 41. For example, the assist execution unit 33 performs the control of notifying the driver of the host vehicle V of the fact that there is a possibility of collision between the host vehicle V and the preceding vehicle with a sound by causing the alarm buzzer 42 to operate. For example, the assist execution unit 33 performs the control of decelerating the host vehicle V or the control of assisting the strength of braking when the brake pedal is pressed by the driver by causing the brake actuator 43 to operate.

Next, a flow of processing by the assist determination unit 32 for determining the necessity of executing the collision avoidance assist control will be described. The determination processing performed by the assist determination unit 32 starts at the time when the TTC and the speed of the host vehicle V are input from the time calculation unit 31. The TTC and the speed of the host vehicle V are input to the assist determination unit 32, for example, for each predetermined time interval. After the TTC and the like are input, the assist determination unit 32 sequentially performs the linear searches with respect to the plurality of search information items stored in the storage unit 5 during the time until the next TTC and the like are input, and determines the necessity of executing collision avoidance assist control with regard to each of the plurality of contents.

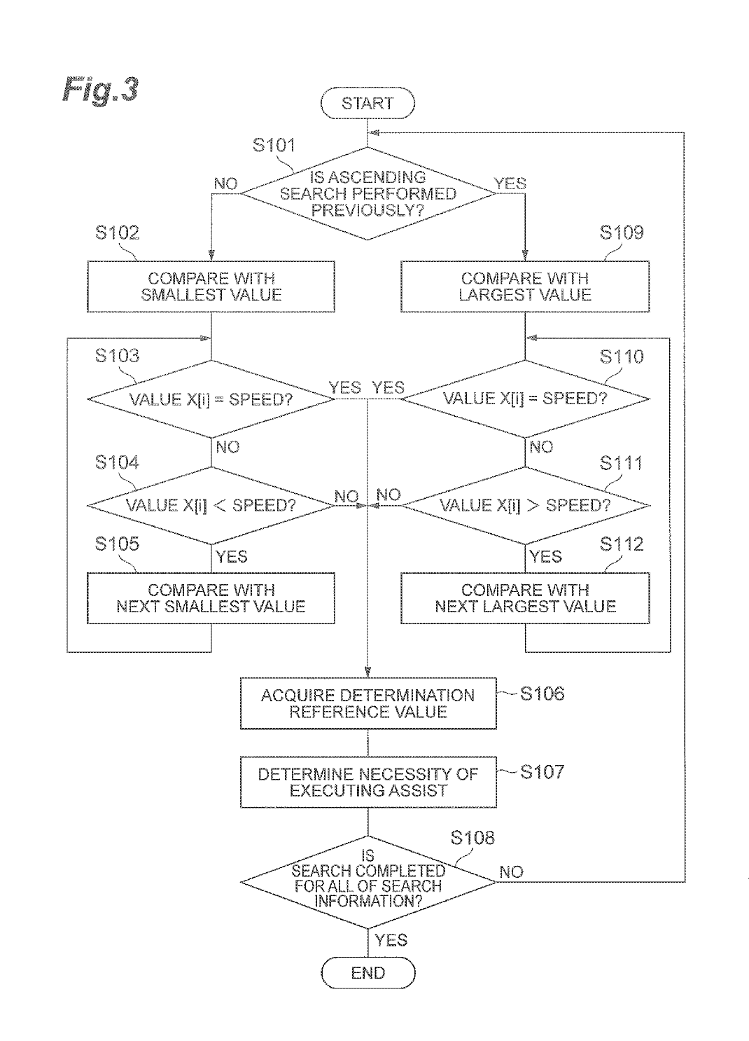

As illustrated in FIG. 3, the search processing unit 32a determines whether or not the linear search previously performed with respect to the search information is the ascending search (S101). In a case where the ascending search is not previously performed (NO in S101), that is, in a case where the descending search is previously performed, the search processing unit 32a performs processing in S102. In a case where there is no linear search previously performed, the search processing unit 32a may perform the processing in S101 under the assumption that a preset search among the ascending search and the descending search is previously performed.

In a case where the ascending search is not previously performed (NO in S101), the search processing unit 32a performs the ascending search. Specifically, the search processing unit 32a compares the input value of the speed with the value X[i] having the smallest value (value X[0]) among the values X[i] included in the search information (S102). Then, the search processing unit 32a determines whether or not the value X[i] and the value of the speed matches each other (S103). In a case where the value X[i] and the value of the speed matches each other (YES in S103), the search processing unit 32a acquires the determination reference value Y[i] associated with the value X[i] (S106).

In a case where the value X[i] and the value of the speed do not match each other (NO in S103), the search processing unit 32a determines whether or not the value X[i] is smaller than the value of the speed (S104). In a case Where the value X[i] is smaller than the value of the speed (YES in S104), the search processing unit 32a compares the next small value X[i] among the values X[i] included in the search information and the value of the speed (S105). After the comparison processing in S105, the search processing unit 32a performs the processing tasks subsequent to S103. In this way, the search processing unit 32a performs the ascending searches in S102 to S105 on the value of the speed which is the target of searching with respect to the search information. Even when comparison of all the values X[i] and the value of the speed is completed, there can be a case where it is not determined to be YES in the processing in S103 and a case where it is not determined to be NO in the processing in S104. In this case, the search processing unit 32a may perform the searches with respect to the next search information.

On the other hand, in a case where the value X[i] is not smaller than the value of the speed (NO in S104), that is, in a case where the value X[i] is greater than the value of the speed, the search processing unit 32a acquires the determination reference value corresponding to the value of the speed (S106). In this case, the search processing unit 32a may acquire the determination reference value corresponding to the value of the speed by performing interpolation or the like.

In addition, in a case where the ascending search is previously performed (YES in S101), the search processing unit 32a performs the descending search. Specifically, the search processing unit 32a compares the input value of the speed with the value X[i] having the largest value (value X[N]) among the values X[i] included in the search information (S109). Then, the search processing unit 32a determines whether or not the value X[i] and the value of the speed matches each other (S110). In a case where the value X[i] and the value of the speed matches each other (YES in S110), the search processing unit 32a acquires the determination reference value Y[i] associated with the value X[i] (S106).

In a case where the value X[i] and the value of the speed do not match each other (NO in S110), the search processing unit 32a determines whether the value X[i] is greater than the value of the speed (S111). In a case where the value X[i] is greater than the value of the speed (YES in S111), the search processing unit 32a compares the next large value X[i] among the values X[i] included in the search information and the value of the speed (S112). After the comparison processing in S112, the search processing unit 32a performs the processing tasks subsequent to S110. In this way, the search processing unit 32a performs the descending searches in S109 to S112 on the value of the speed which is the target of searching with respect to the search information. Even when comparison of all the values X[i] and the values of the speed is completed, there can be a case where it is not determined to be YES in the processing in S110 and a case where it is not determined to be NO in the processing in S111. In these cases, the search processing unit 32a may perform the search with respect to the next search information.

On the other hand, in a case where the value X[i] is not greater than the value of the speed (NO in S111), that is, in a case where the value X[i] is smaller than the value of the speed, the search processing unit 32a acquires the determination reference value corresponding to the value of the speed (S106). In this case, the search processing unit 32a may acquire the determination reference value corresponding to the value of the speed by performing interpolation or the like.

After acquiring the determination reference value in S106, the determination processing unit 32b compares the acquired determination reference value and the input TTC. The determination processing unit 32b determines the necessity of executing the collision avoidance assist control based on the comparison result (S107). The search processing unit 32a determines whether or not the search is completed with respect to all of the search information items (S108). In a case where the search is not completed with respect to all of the search information items NO in S108), the assist determination unit 32 performs the above-described processing tasks subsequent to S101 with respect to the next search information. In a case where the search is completed with respect to all of the search information items (YES in S108), the search processing unit 32a ends the search processing.

The present embodiment is configured as described above, and when sequentially performing the linear searches on the search target value with respect to each of the plurality of search information items, the drive assist apparatus 100 alternately performs the ascending search and the descending search with respect to each of the search information items. For example, when the value of the speed which is the search target value is large, in a case of searching the search target value by the ascending search with respect to the search information, the number of searches increases. In addition, when the value of the speed which is the search target value is large, in a case of searching the search target value by the descending search with respect to the search information, the number of searches decreases. For this reason, when sequentially performing the linear search on the search target value with respect to each of the plurality of search information items, the drive assist apparatus 100 alternately performs the ascending search and the descending search with respect to each of the search information items, and thus, it is possible to suppress the increase of maximum value of the total number of searches in all of the plurality of search information items.

When performing the calculation processing for the collision avoidance assist control as the calculation processing for the drive assist. control, the drive assist apparatus 100 alternately performs the ascending search and the descending search on each search information. In this way, the drive assist apparatus 100 can suppress the increase of maximum value of the processing load in the collision avoidance assist control.

Here, the suppressing the increase of the maximum value of the total number of searches in all of the plurality of search information items will be described in detail. Hereinafter, the cases of performing the linear search on the search information illustrated in FIG. 2A and the search information illustrated in FIG. 2B will he described. The value of the determination reference value Y[i] associated with the value X[i] in the search information illustrated FIG. 2B is different from that in the search information illustrated in FIG. 2A. The search information illustrated in FIG. 2A will be referred to as search information A and the search information illustrated FIG. 2B will be referred to as search information B. The values X[i] of the search information A and the search information B are mutually the same. In addition, the case where the search processing unit 32a searches the value X of the speed as the search target value will be described.

For example, in a case where the search processing unit 32a performs the ascending search on the value X of the speed with respect to the search information A, the number of searches is i+1 (i=0 to N).

Next, in a case where the search processing unit 32a performs the descending search on the value X of the speed with respect to the search information B, the number of searches is N−i+1 (i=0 to N. In a case of searching the value X of the speed with respect to the search information A and the search information B, the total number of searches is N+2. That is, the total number of searches becomes a constant number regardless of the value X of the speed. As described above, by performing the ascending search and the descending search on each search information, it is possible to suppress the increase of maximum value of total number of searches in the search information A and the search information B.

On the other hand, in a case where only the ascending search is performed with respect to the search information A and the search information B, when the value X of the speed is large (in a case where the value X of the speed is close to the value X[N]), the total number of searches in the search information A and the search information B increases. Alternatively, in a case where only the descending search is performed with respect to the search information A and the search information B, when the value X of the speed is small (in a case where the value X of the speed is close to the value X[0]), the total number of searches in the search information A and the search information B increases. In contrast, by alternately performing the ascending search and the descending search, the search processing unit 32a in the present embodiment can suppress the increase of the total number of searches according to the magnitude of the value X of the speed as in the case where only the ascending search or only the descending search is performed.

As described above, the embodiment of the present invention is described. However, the present invention is not limited to the above-described embodiment. For example, the drive assist apparatus 100 may perform an assist other than the collision avoidance assist as the drive assist. As an example, as the drive assist, the drive assist apparatus 100 may perform a lane keeping assist for controlling the vehicle such that the lateral position of the vehicle becomes the target lateral position in the travelling lane.

The external sensor 1 may include a laser radar, an ultrasonic sensor, a laser imaging detection and ranging (LIDAR), or the like instead of the millimeter wave radar 11 as long as those sensors are capable of detecting an obstacle. Alternatively, the external sensor 1 may include a stereo camera and may detect an obstacle from the image captured by the stereo camera by image processing.

The search processing unit 32a searches the value of the speed of the external sensor 1 from the search information. However, a value other than the speed may he searched. As an example, the search processing unit 32a may search a value of acceleration, a steering angle, a yaw rate, or a distance to the preceding vehicle from the search information. In this case, the host vehicle information acquisition unit 2 includes an acceleration sensor, a steering angle sensor, or a yaw rate sensor, and inputs the detection result to the drive assist ECU 3. The search processing unit 32a searches the value of the acceleration, the steering angle, the yaw rate input from the host vehicle information acquisition unit 2 from the search information, and acquires the determination reference value. Alternatively, the search processing unit 32a may search the value of the distance between the preceding vehicle and the host vehicle V from the search information. In this case, the search processing unit 32a may recognize the distance to the preceding vehicle based on the obstacle information from the millimeter wave radar 11. Then, the search processing unit 32a searches the value of the distance between the recognized preceding vehicle and the host vehicle V from the search information, and then, acquires the determination reference value.

The assist device 4 may include devices other than the display unit 41, the alarm buzzer 42, and the brake actuator 43. For example, the assist device 4 may include a seat belt winding unit that winds a seat belt when there is a possibility of collision with the obstacle or a suspension performance changing unit that changes the damping force of the suspension or the vehicle height when there is a possibility of collision with the obstacle, in this case, the assist execution unit 33 causes the seat belt winding unit or the suspension performance changing unit to operate based on the determination result of the determination processing unit 32b.

What is claimed is:

1. A drive assist apparatus comprising:
a search unit configured to, in calculation processing in a drive assist control of a vehicle, perform a linear search with respect to search information formed of a plurality of values,
wherein, in a ease of performing the linear search on a search target value Which is a target of searching with respect to each of a plurality of search information items, the search unit alternately performs an ascending search and a descending search with respect to each search information.

2. The drive assist apparatus according to claim 1,
wherein the drive assist control is a collision avoidance assist control for assisting the collision avoidance between a host vehicle and an obstacle around the host vehicle, the apparatus further comprising:
a time calculation unit configured to calculate a time to collision which is a time for the host vehicle and the obstacle to collide with each other;
a speed detection unit configured to detect a speed of the host vehicle;
an assist unit configured to perform an assist for avoiding the collision between the host vehicle and the obstacle; and
a storage unit configured to store the plurality of search information items,
wherein a determination reference value which is a reference for determining the necessity of executing the collision avoidance assist control is associated with each value forming the search information,
wherein the search unit performs linear searches on the value of the speed detected by the speed detection unit as the search target value with respect to each of the plurality of search information items stored in the storage unit, and determines the necessity of executing the collision avoidance assist control based on the determination reference value associated with the found value and the time to collision calculated by the time calculation unit, and
wherein the assist unit executes the collision avoidance assist control based on the result of the determination by the search unit.
